(19) United States
(12) Patent Application Publication
(10) Pub. No.: US 2026/0089068 A1
(43) Pub. Date: Mar. 26, 2026

(54) METHOD FOR PREDICTING INTERNET OF THINGS (IOT) DATA INCONSISTENCY

(71) Applicant: TELEFONAKTIEBOLAGET LM ERICSSON (PUBL), Stockholm (SE)

(72) Inventors: Carla MOURADIAN, Montreal (CA); Mbarka SOUALHIA, Laval (CA)

(73) Assignee: TELEFONAKTIEBOLAGET LM ERICSSON (PUBL), Stockholm (SE)

(21) Appl. No.: 19/108,629

(22) PCT Filed: Sep. 8, 2022
(86) PCT No.: PCT/IB2022/058475

§ 371 Date: Mar. 4, 2025

(51) Int. Cl. H04L 41/147; G06F 16/906; H04L 41/16; H04L 67/12

(52) U.S. Cl. CPC H04L 41/147; G06F 16/906; H04L 41/16; H04L 67/12

(57) ABSTRACT

The disclosure relates to a method and apparatus for predicting Internet of Things (IoT) data inconsistency. The method comprises obtaining labelled IoT data, the IoT data being collected from a plurality of IoT devices by a monitoring system. The method comprises analyzing characteristics of the labelled IoT data and identifying features of IoT data inconsistency. The method comprises training, using the labelled IoT devices data and the features of IoT data inconsistency, a ML model to predict the IoT data inconsistency. The method comprises generating, using the labelled IoT data and the features of IoT data inconsistency, a set of inconsistency rules to be applied to live IoT data predicted as inconsistent by the ML model.

### TECHNICAL FIELD

The present disclosure relates to data inconsistency detection and remediation in Internet of Things (IoT) data.

### BACKGROUND

Internet of Things (IoT) is considered as a stepping-stone in building modern wireless telecommunication systems. IoT devices are heterogeneous and use various protocols to serve the different applications hosted in edge clouds. The quality of services offered by these applications highly rely on the quality of the data collected from the IoT systems. However, while collecting such data, many problems can occur and cause data inconsistency. Data inconsistency refers to data values in one data set not being consistent with values in another data set. This means that the collected data may be changed differently or may not be synchronized between the source and destination in the IoT system. One reason behind such inconsistency could be the sampling rate of IoT devices: there can exist a high number of IoT devices serving an application, and hence changing sampling rate for many devices is a tedious task and is not efficient. In addition, the IoT devices could serve more than one application (e.g., virtual sensors). In that case, changing the sampling rate for a single application might affect the performance of the other applications. Furthermore, IoT devices are heterogeneous and use various application protocols e.g., Constrained Application Protocol (CoAP), Message Queuing Telemetry Transport (MQTT), Extensible Messaging and Presence Protocol (XMPP), etc. These devices may serve different providers and may experience different communication conditions (e.g., different network delays).

### SUMMARY

It is therefore of interest to design an automated system/architecture to dynamically identify reasons behind data inconsistency in IoT systems and hence early identify such events to avoid their impacts on IoT applications hosted in edge cloud.

There is provided a computer implemented method for predicting Internet of Things (IoT) data inconsistency. The method comprises obtaining labelled IoT data, the IoT data being collected from a plurality of IoT devices by a monitoring system. The method comprises analyzing characteristics of the labelled IoT data and identifying features of IoT data inconsistency. The method comprises training, using the labelled IoT devices data and the features of IoT data inconsistency, a ML model to predict the IoT data inconsistency. The method comprises generating, using the labelled IoT data and the features of IoT data inconsistency, a set of inconsistency rules to be applied to live IoT data predicted as inconsistent by the ML model.

There is provided an apparatus for predicting Internet of Things (IoT) data inconsistency. The apparatus comprises processing circuits and a memory. The memory contains instructions executable by the processing circuits whereby the apparatus is operative to obtain labelled IoT data, the IoT data being collected from a plurality of IoT devices by a monitoring system. The apparatus is operative to analyze characteristics of the labelled IoT data and identify features of IoT data inconsistency. The apparatus is operative to train, using the labelled IoT devices data and the features of IoT data inconsistency, a ML model to predict IoT data inconsistency. The apparatus is operative to generate, using the labelled IoT data and the features of IoT data inconsistency, a set of inconsistency rules to be applied to live IoT data predicted as inconsistent by the ML model.

There is provided a non-transitory computer readable media having stored thereon instructions for predicting Internet of Things (IoT) data inconsistency, the instructions may comprise any of the steps described herein.

The method and apparatus provided herein present improvements to the way data inconsistency detection and remediation in IoT data operate.

### BRIEF DESCRIPTION OF THE DRAWINGS

FIG. 1 is a block diagram illustrating deployment options for the proposed IoT data inconsistency predictor.

FIG. 2 is a schematic high-level view of the proposed system.

FIG. 3 is a flowchart of a method for the proposed IoT data inconsistency prediction.

FIG. 4 is the first part of a flowchart of an example of IoT data inconsistency prediction.

FIG. 5 is the second part of the flowchart of the example of IoT data inconsistency prediction.

FIG. 6 is a flowchart of a method for predicting Internet of Things (IoT) data inconsistency.

FIG. 7 is a schematic illustration of an apparatus in which steps of the method described herein can be executed.

FIG. 8 is a schematic illustration of a virtualization environment in which the different method(s) and hardware components described herein can be deployed.

### DETAILED DESCRIPTION

Various features will now be described with reference to the drawings to fully convey the scope of the disclosure to those skilled in the art.

Sequences of actions or functions may be used within this disclosure. It should be recognized that some functions or actions, in some contexts, could be performed by specialized circuits, by program instructions being executed by one or more processors, or by a combination of both.

Further, computer readable carrier or carrier wave may contain an appropriate set of computer instructions that would cause a processor to carry out the techniques described herein.

The functions/actions described herein may occur out of the order noted in the sequence of actions or simultaneously. Furthermore, in some illustrations, some blocks, functions or actions may be optional and may or may not be executed; these are generally illustrated with dashed lines.

At least some aspects of the techniques described herein may be implemented using artificial intelligence, which comprises a variety of techniques as would be apparent to a person skilled in the art, including machine learning techniques. Machine learning techniques include Neural Network (NN), or Artificial Neural Network (ANN), and both terms may be used interchangeably herein.

Herein, a solution for predicting data inconsistency in IoT systems is provided as an extension to inconsistency detection and resolution solutions. The proposed solution takes as input data collected from IoT systems (historical and live data) along with characteristics of these IoT systems (type, location, sampling rate, requirements, etc.). It builds machine learning (ML)-based model (e.g., Long Short-Term Memory (LSTM), Convolutional Neural Network (CNN) models, etc.) to identify data inconsistency with IoT data early. It generates as output the main factors contributing to data inconsistency, prediction results, and a set of inconsistency rules to handle predicted data inconsistency.

Traditional “resolution” components solve the inconsistencies after they happen, e.g., they remove inconsistent data. Therefore, the existing “resolution” component is also extended, to be able to avoid inconsistency before its occurrence. The main factors contributing to data inconsistency and the inconsistency rules are added to refine the resolution actions (e.g., update data collection sources).

The proposed system allows to detect data inconsistency with IoT systems early and take appropriate actions to prevent data inconsistency events in the future. It allows building inconsistency rules that can be used by both inconsistency prediction and detection solutions. It allows to identify the main contributing factors contributing to data inconsistency: which can be used to refine/improve the existing inconsistency detection models in terms of accuracy, relevance, etc. It also can be applied to other types of data inconsistency that could be detected when collecting data such as routing packets, database, etc.

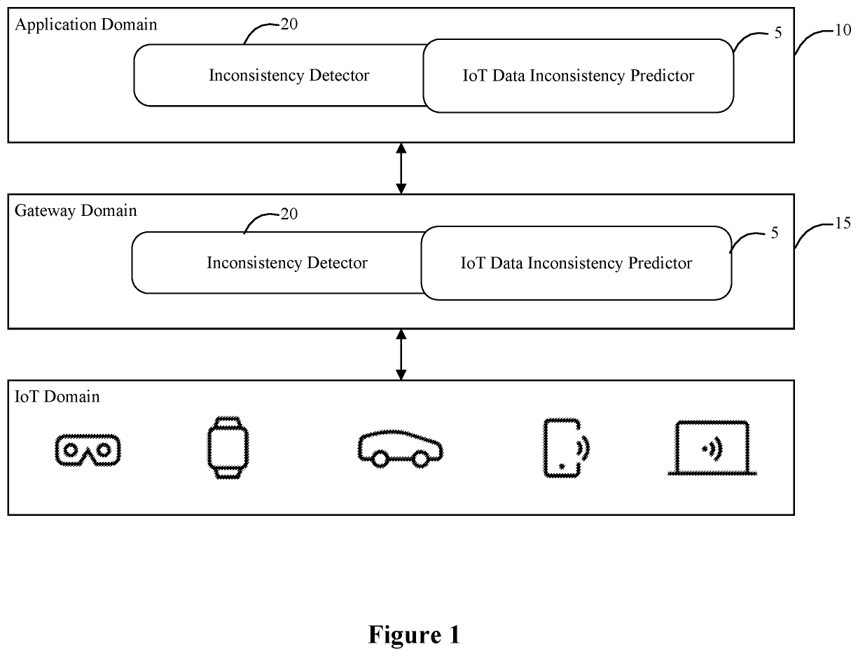

Referring to FIG. 1, the proposed IoT data inconsistency predictor system 5 is described. FIG. 1 presents the way the proposed system intersects or resides in existing IoT architecture layers. The proposed system can be deployed in the application layer 10 or the network layer 15 (i.e., IoT gateways). This depends on whether an existing inconsistency detector 20 solution is deployed or not. In the case of the existence of an inconsistency detector 20, the proposed solution can extend it to provide additional functionalities and improve the existing functionalities. If an inconsistency detector 20 solution does not exist, then the proposed system can be deployed either in the application layer 10 or the network layer 15 according to the provider preference.

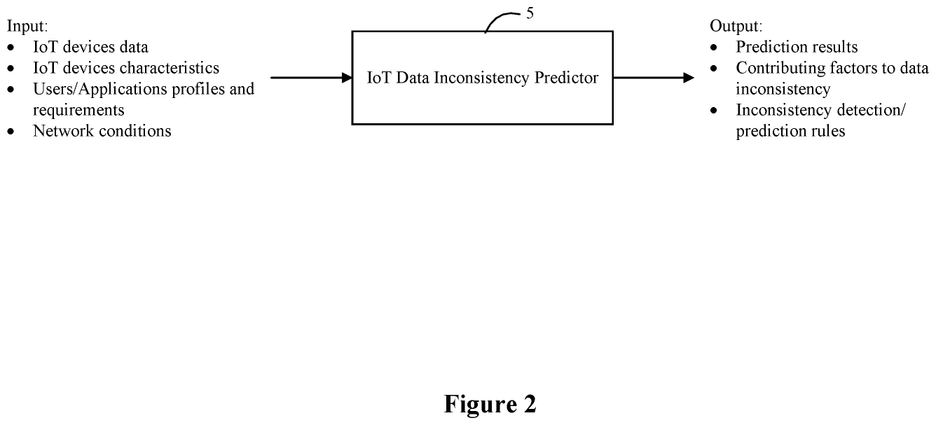

FIG. 2 shows the proposed IoT data inconsistency predictor system 5.

The system takes as input the data from IoT devices along with the IoT devices characteristics such as their type (e.g., sensor, actuator), location, destination, sampling rate, etc. The system also takes the application requirements (e.g., service level agreement (SLA)) and profiles, and the network conditions into consideration.

The main functionality of the IoT data inconsistency predictor 5 is to predict and identify IoT data inconsistency early, using historical data collected from the IoT devices and the profiles of the applications provided by the users/application provider. To do this, the IoT data inconsistency predictor 5 first identifies the causing factors that contributed the most to the data inconsistency. These factors are then used to build ML-based prediction models to identify data inconsistency on the live data collected from the IoT devices. These factors are also used to build inconsistency prediction rules that assist in inconsistency detection/prediction.

After predicting IoT data inconsistency, the system generates as output the prediction results and the main factors contributing to the data inconsistency. It also builds a set of inconsistency rules using the prediction results to assist in inconsistency prediction and avoidance.

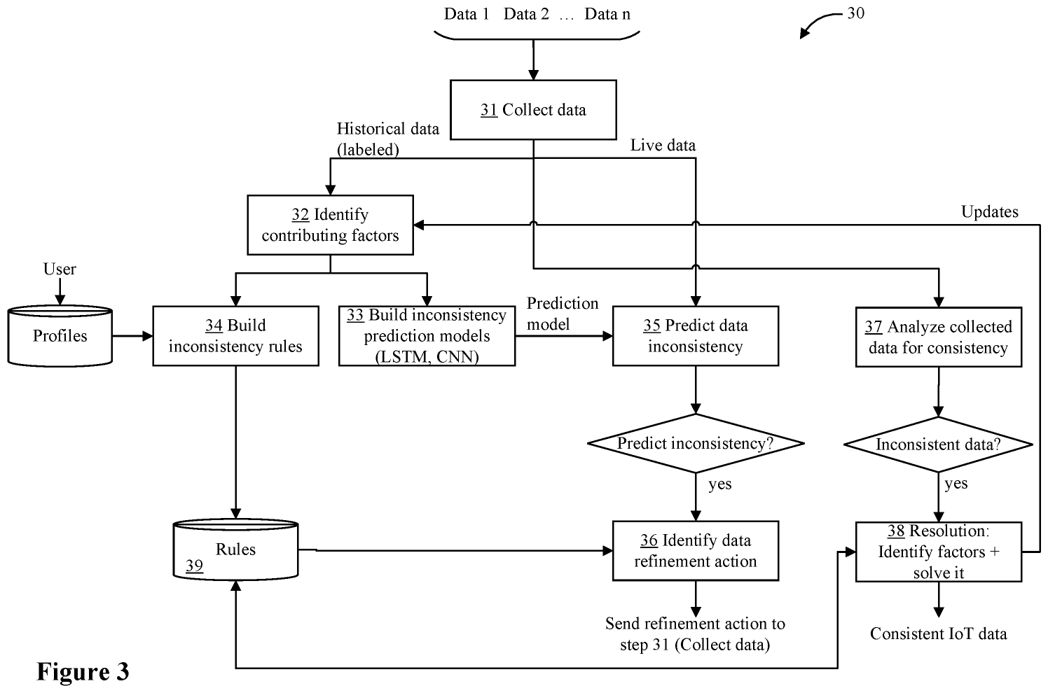

FIG. 3 shows the flowchart of the proposed method for IoT data inconsistency prediction. The flowchart contains and integrates two parts: the inconsistency detector 20 (boxes 31, 37 and 38) and the inconsistency predictor 5 (boxes 32-36). The IoT data inconsistency predictor 5 works as follows.

The method 30 starts by collecting, step 31, historical input data (labeled) from a monitoring system.

Then, it identifies, step 32, the contributing factors of data inconsistency using labeled historical data and user profiles. The user profiles could include user-specified information on the data, for instance, where to collect data from, required sampling rate, application specifications (e.g., latency-sensitive, data-dependent), etc. The historical data are labeled data that includes the IoT devices' data, characteristics (e.g., type, location, destination, sampling rate), and their network conditions and whether the data was consistent or not.

The method measures the degree of correlation between all these factors, which are also called features. The Spearman's correlation coefficient (Bishara, Anthony J., and James B. Hittner. “Testing the significance of a correlation with nonnormal data: comparison of Pearson, Spearman, transformation, and resampling approaches.” Psychological methods 17.3 (2012): 399.) can be used between all these identified features.

The resulting correlation coefficient would be a matrix with N rows and N columns such that N defines the number of obtained feature elements. The obtained correlation matrix could be used as an indication of the degree of relationship between the feature elements in the obtained matrix. The method 30 uses this matrix to select the most relevant features that are inter-correlated with the data inconsistency.

According to the defined contributing causes, prediction models are built, step 33. The output of this step is prediction model(s). These models are used to predict data inconsistency on the live data collected from the IoT devices. For this step, different machine learning models can be used such as LSTM, CNN, etc.

Using the contributing factors, inconsistency detection/prediction rules are also built, step 34. This step is complemented by using the user Profiles. These rules are saved in the rules repository 39 which helps in the prevention and the avoidance of IoT data inconsistency.

In step 35, the method performs data inconsistency prediction on the live data.

If an inconsistency is predicted, data refinement actions are generated, step 36, using the rules in the rules repository 39. These actions are sent to step 31 (i.e., collect data) to guide the live data collection process such that future inconsistencies are avoided or reduced as much as possible.

In step 37, the method analyzes the collected live data to see if there is any inconsistency. Different methods are known for that purpose such as performing consistency checks, hop counts for routing tables, comparisons based on thresholds, etc. In the present method, it is proposed to use user-profiles and ML techniques.

Once an inconsistency is detected, the method proposes, step 38, a solution to solve it. This is an improvement over known method which, to solve inconsistency, simply remove the inconsistent data. In the solution presented herein, the contributing factors for data inconsistency are identified, such as the sampling rate, then the rules repository that contains a set of rules is used to find the best candidate solution to be applied considering the identified contributing factor, to recover from the detected inconsistency.

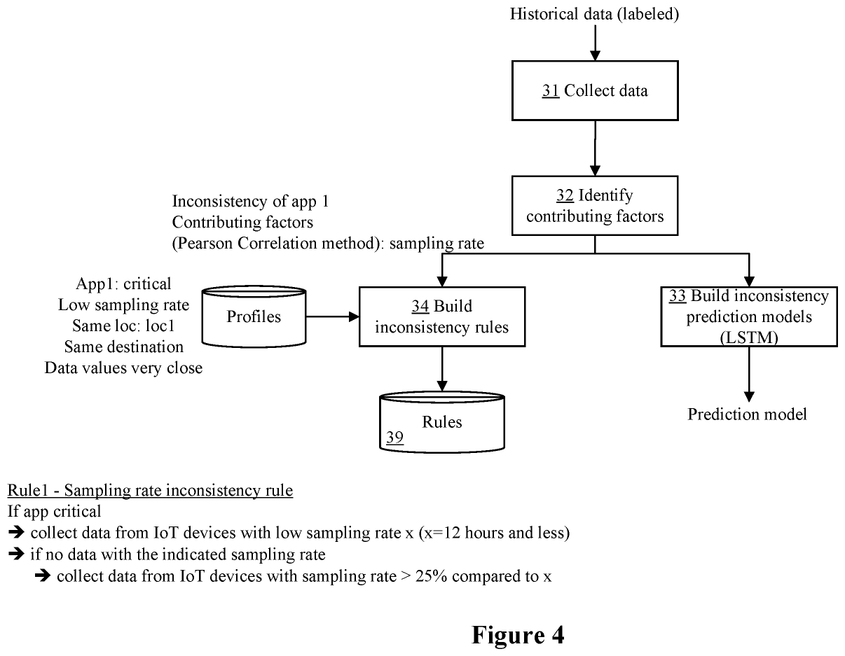

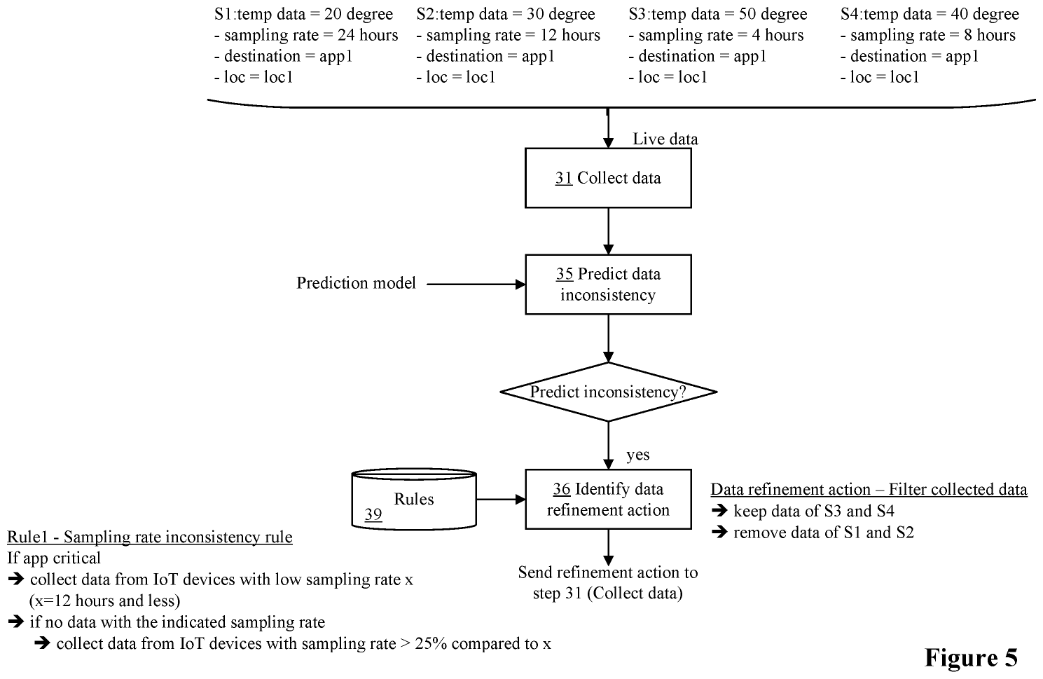

FIGS. 4 and 5 illustrate an example of the proposed IoT data inconsistency predictor 5. The purpose of this example is to illustrate the different steps of FIG. 3 in a simplified manner.

In FIG. 4, the steps 31-34, performed on the historical data are shown. In this part, the historical data (labeled) is collected, step 31, first from the IoT devices.

The method then identifies, step 32, the most relevant features or factors, contributing factors, that have an impact on the consistency of the IoT devices' data. In this example, it is assumed that the sampling rate was identified as the most contributing factor to the IoT data inconsistency.

According to the contributing factors, inconsistency rules are built, step 34. At this step, the application/user profiles are used to assist in building meaningful inconsistency rules. An example of an inconsistency rule, Rule 1, is shown in FIG. 4. The rule says that the collected data for app 1 should have a low sampling rate since this app is a critical application and it requires the latest collected data, for example within the latest 1 hour. The method then updates the rules repository 39 with the new rule that is built.

The method also builds, step 33, inconsistency prediction models using the contributing factors. For this step, the method obtains different data parameters, characterizes the collected data, and builds prediction models to predict expected data inconsistency.

To build the prediction models, for example, LSTM can be used, and the following steps can be applied. First, historical data is collected. Then, contributing factors to data inconsistency are identified, this step can be done using the Spearman correlation coefficient. The ML model (e.g., LSTM) is then trained using this data. The historical data can be splitted into training and testing data to prevent the model from overfitting. Cross validation or K-fold cross validation can be used for data splitting, where a model is trained and evaluated “k” times on different samples. The model is trained to classify the future live data into two categories: consistent or inconsistent. The trained prediction model is used later on the live data to detect if there is any consistency. Its output indicates either “yes” meaning there is inconsistency or “no” indicating no inconsistency.

Finally, the method outputs the prediction model that is built to be used for inconsistency prediction on the live data.

In FIG. 5, the steps performed on the live data are shown. In this part, the method collects, step 31, live data from the IoT devices. This can include the raw data, the IoT devices' characteristics (such as sampling rate, their location, target destination, etc.), and their network conditions.

It then performs data inconsistency prediction, step 35, using the prediction model generated in FIG. 4.

If data inconsistency is predicted, it generates, step 36, data refinement actions using the rules in the rules repository 39. For instance, following the rule (Rule 1) generated in FIG. 4, the method suggests filtering the collected data by keeping only the data collected from sensors 3 and 4 (i.e., S3 and S4) since these sensors have a low sampling rate and satisfy the inconsistency rule in the rules repository, and remove the data collected from S1 and S2.

Finally, it sends data refinement actions to the entity that collects live data, such that data inconsistency can be avoided in the future.

The rules identified by the method can also assist in the data inconsistency detection procedure on the live data. The identified rules can predict the inconsistency before it happens. However, the same rules can be applied by the data inconsistency detection system, where an inconsistency is detected after it happens. When used to predict inconsistency, the system can take same preemptive actions to avoid inconsistency. For instance, following the example above, the data inconsistency detection can utilize this sampling rate rule to avoid collecting data from specific sensors (identified previously with a high sampling rate). In this way, the system can avoid data inconsistency and collects less amount of data to be analyzed.

It should be noted that methods and steps described herein are, generally, computer implemented methods and steps. The term computer may be interpreted as having different meanings, such apparatus, gateway, etc.

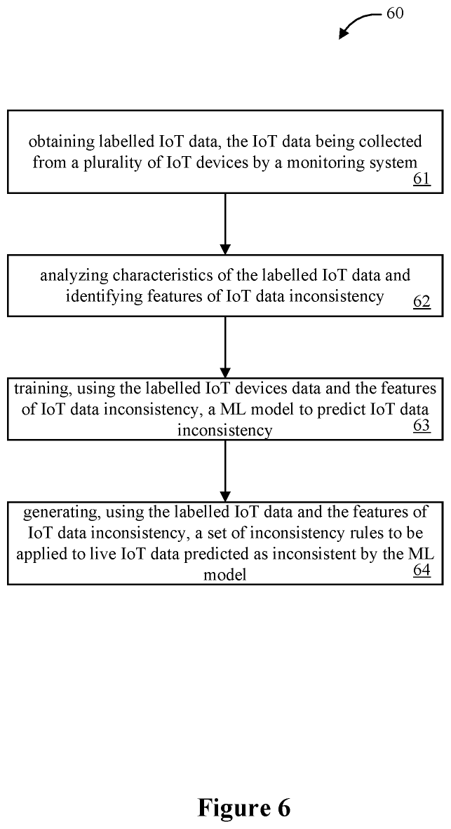

FIG. 6 illustrates a computer implemented method 60 for predicting Internet of Things (IoT) data inconsistency. The method comprises obtaining, step 61, labelled IoT data, the IoT data being collected from a plurality of IoT devices by a monitoring system. The method comprises analyzing, step 62, characteristics of the labelled IoT data and identifying features of IoT data inconsistency. The method comprises training, step 63, using the labelled IoT devices data and the features of IoT data inconsistency, a ML model to predict the IoT data inconsistency. The method comprises generating, step 64, using the labelled IoT data and the features of IoT data inconsistency, a set of inconsistency rules to be applied to live IoT data predicted as inconsistent by the ML model.

The labelled IoT data may comprise the IoT data of a plurality of IoT devices and a plurality of features for each of the IoT data including at least one of: a type of IoT data, a type of IoT device, a location of acquisition of the IoT data, a time of acquisition of the IoT data, a destination for the IoT data, a sampling rate of the IoT data, a latency-sensitiveness of the IoT data, a network condition when the IoT data was acquired, and an indication whether the IoT data is consistent or not.

It should be noted that the same IoT data can serve both latency-sensitive and non-sensitive application. The latency-sensitive application may require the data quickly.

Analyzing the characteristics of the labelled IoT data may comprise measuring a degree of correlation between features of the labelled IoT data. The degree of correlation may be measured using Spearman's correlation coefficients between the features of the labelled IoT data. The resulting correlation coefficients may form a matrix with N rows and N columns, where N defines a number of feature elements. Values of the matrix may indicate a degree of relationship between the feature elements. The feature elements having a higher degree of relationship with the IoT data inconsistency may be selected as the features of IoT data inconsistency.

The set of inconsistency rules may further be used for refining the IoT data collected from the plurality of IoT devices for continuous training of the ML model.

Training the ML model may comprise training a plurality of ML models to address different types of performance in terms of accuracy, precision, recall and F1-score. The plurality of ML models may be selected among Recurrent Neural Network (RNN), Long Short-Term Memory (LSTM) and Convolutional Neural Network (CNN). A person skilled in the art would understand that other equivalent models, not listed by name, could be alternatively used.

The method may further comprise performing data inconsistency prediction on live IoT data, using the ML model. The method may further comprise, if a data inconsistency of live IoT data is predicted, generating refinement actions using the set of inconsistency rules. The method may further comprise using the refinement actions to guide live data collection to avoid future inconsistencies. The method may further comprise performing a data inconsistency verification on live IoT data, using the ML model and information in the labeled IoT data. The method may further comprise, if a data inconsistency is verified, generating a resolution action using the set of inconsistency rules, to fix the IoT data inconsistency.

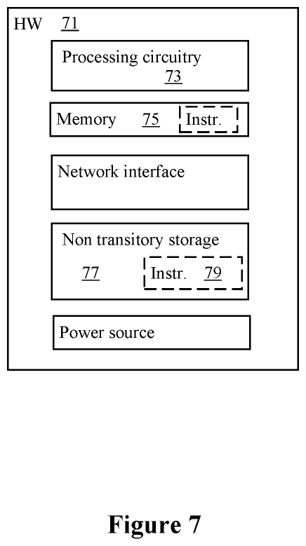

Referring to FIG. 7, there is provided an apparatus (HW) 71, in which functions and steps described herein can be implemented. Alternatively, the functions and steps described herein can be implemented in a virtual hardware instance, in an application or any equivalent, e.g. in the application domain.

The apparatus 71 may be an IoT gateway, server, network node, radio base station, or other computing device which may be part of a cloud computing system, edge computing system, or which may be a standalone device.

The apparatus may reside in the gateway domain or in the application domain. The apparatus (physical or virtual) may be used in conjunction with an existing inconsistency detector to improve its operation and performance. The apparatus may be used to detect and predict IoT data inconsistencies as well as to remedy such inconsistencies, for example by modifying the way future IoT data is collected.

The apparatus 71 comprises processing circuitry 73 and memory 75. The memory 75 can contain instructions executable by the processing circuitry 73 whereby functions and steps described herein may be executed to provide any of the relevant features and benefits disclosed herein.

The apparatus 71 may also include non-transitory, persistent, machine-readable storage media 77 having stored therein software and/or instruction 79 executable by the processing circuitry 73 to execute functions and steps described herein. The apparatus may also include network interface(s) and a power source.

The instructions 79 may include a computer program for configuring the processing circuitry 73. The computer program may be stored in a physical memory local to the device, which can be removable, or it could alternatively, or in part, be stored in the cloud. The computer program may also be embodied in a carrier such as an electronic signal, optical signal, radio signal, or computer readable storage medium.

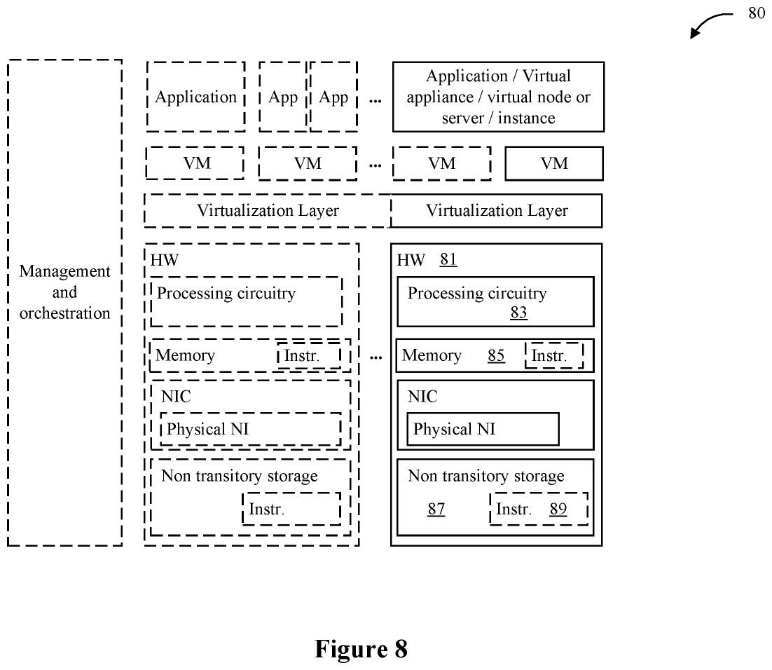

Referring to FIG. 8, there is provided a virtualization environment 80 in which functions and steps described herein can be implemented.

The virtualization environment 80 (which may go beyond what is illustrated in FIG. 8), may comprise systems, networks, servers, nodes, devices, etc., that are in communication with each other either through wire or wirelessly, e.g. through a network interface component (NIC) comprising physical network interface(s). Some or all of the functions and steps described herein may be implemented as one or more virtual components (e.g., via one or more applications, components, functions, virtual machines, containers, etc.) executing on one or more physical apparatus in one or more networks, systems, environment, etc.

A virtualization environment provides hardware 81 comprising processing circuitry 83 and memory 85. The memory 85 can contain instructions executable by the processing circuitry 83 whereby functions and steps described herein may be executed to provide any of the relevant features and benefits disclosed herein.

The hardware 81 may also include non-transitory, persistent, machine readable storage media 87 having stored therein software and/or instruction 89 executable by the processing circuitry 83 to execute functions and steps described herein.

The instructions 89 may include a computer program for configuring the processing circuitry 83. The computer program may be stored in a removable memory, such as a portable compact disc, portable digital video disc, or other removable media. The computer program may be stored in a physical memory local to the hardware 81, which can be removable, or it could alternatively, or in part, be stored in the cloud. The computer program may also be embodied in a carrier such as an electronic signal, optical signal, radio signal, or computer readable storage medium.

Referring to FIGS. 7 and 8, there is provided an apparatus, 71, 81 for predicting Internet of Things (IoT) data inconsistency. The apparatus comprises processing circuits 73, 83 and a memory 75, 85, the memory containing instructions executable by the processing circuits whereby the apparatus is operative to obtain labelled IoT data, the IoT data being collected from a plurality of IoT devices by a monitoring system. The apparatus is operative to analyze characteristics of the labelled IoT data and identify features of IoT data inconsistency. The apparatus is operative to train, using the labelled IoT devices data and the features of IoT data inconsistency, a ML model to predict IoT data inconsistency. The apparatus is operative to generate, using the labelled IoT data and the features of IoT data inconsistency, a set of inconsistency rules to be applied to live IoT data predicted as inconsistent by the ML model. The apparatus may be a data inconsistency resolution system. The apparatus may be an IoT gateway. The apparatus may be further operative to execute any of the steps described herein.

Still referring to FIGS. 7 and 8, there is provided a non-transitory computer readable media 77, 87 having stored thereon instructions 79, 89 for predicting Internet of Things (IoT) data inconsistency. The instructions may comprise any of the steps described herein.

Modifications will come to mind to one skilled in the art having the benefit of the teachings presented in the foregoing description and the associated drawings. Therefore, it is to be understood that modifications, such as specific forms other than those described above, are intended to be included within the scope of this disclosure. The previous description is merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

1. A computer implemented method for predicting Internet of Things (IoT) data inconsistency, comprising:
obtaining labelled IoT data, the IoT data being collected from a plurality of IoT devices by a monitoring system;
analyzing characteristics of the labelled IoT data and identifying features of IoT data inconsistency;
training, using the labelled IoT devices data and the features of IoT data inconsistency, a ML model to predict the IoT data inconsistency; and
generating, using the labelled IoT data and the features of IoT data inconsistency, a set of inconsistency rules to be applied to live IoT data predicted as inconsistent by the ML model.

2. The method of claim 1, wherein the labelled IoT data comprises the IoT data of a plurality of IoT devices and a plurality of features for each of the IoT data including at least one of: a type of IoT data, a type of IoT device, a location of acquisition of the IoT data, a time of acquisition of the IoT data, a destination for the IoT data, a sampling rate of the IoT data, a latency-sensitiveness of the IoT data, a network condition when the IoT data was acquired, and an indication whether the IoT data is consistent or not.

3. The method of claim 1, wherein analyzing characteristics of the labelled IoT data comprises measuring a degree of correlation between features of the labelled IoT data.

4. The method of claim 3, wherein the degree of correlation is measured using Spearman's correlation coefficients between the features of the labelled IoT data.

5. The method of claim 4, wherein the resulting correlation coefficients form a matrix with N rows and N columns; wherein N defines a number of feature elements; wherein values of the matrix indicates a degree of relationship between the feature elements; and wherein the feature elements having a higher degree of relationship with the IoT data inconsistency are selected as the features of IoT data inconsistency.

6. The method of claim 1 wherein the set of inconsistency rules is further used for refining the IoT data collected from the plurality of IoT devices for continuous training of the ML model.

7. The method of claim 1, wherein training the ML model comprises training a plurality of ML models to address different types of performance in terms of accuracy, precision, recall and F1-score.

8. The method of claim 7, wherein the plurality of ML models is selected among Recurrent Neural Network (RNN), Long Short-Term Memory (LSTM) and Convolutional Neural Network (CNN).

9. The method of claim 1, further comprising performing data inconsistency prediction on live IoT data, using the ML model.

10. The method of claim 9, further comprising, if a data inconsistency of live IoT data is predicted, generating refinement actions using the set of inconsistency rules.

11. The method of claim 10, further comprising using the refinement actions to guide live data collection to avoid future inconsistencies.

12. The method of claim 1, further comprising, performing a data inconsistency verification on live IoT data, using the ML model and information in the labeled IoT data.

13. The method of claim 12, further comprising, if a data inconsistency is verified, generating a resolution action using the set of inconsistency rules, to fix the IoT data inconsistency.

14. An apparatus for predicting Internet of Things (IoT) data inconsistency comprising processing circuits and a memory, the memory containing instructions executable by the processing circuits whereby the apparatus is operative to:
obtain labelled IoT data, the IoT data being collected from a plurality of IoT devices by a monitoring system;
analyze characteristics of the labelled IoT data and identify features of IoT data inconsistency;
train, using the labelled IoT devices data and the features of IoT data inconsistency, a ML model to predict IoT data inconsistency; and
generate, using the labelled IoT data and the features of IoT data inconsistency, a set of inconsistency rules to be applied to live IoT data predicted as inconsistent by the ML model.

15. The apparatus of claim 14, wherein the apparatus is a data inconsistency resolution system.

16. The apparatus of claim 14, wherein the apparatus is an IoT gateway.

17. (canceled)

18. A non-transitory computer readable media having stored thereon instructions for predicting Internet of Things (IoT) data inconsistency, the instructions comprising:
obtaining labelled IoT data, the IoT data being collected from a plurality of IoT devices by a monitoring system;
analyzing characteristics of the labelled IoT data and identifying features of IoT data inconsistency;
training, using the labelled IoT devices data and the features of IoT data inconsistency, a ML model to predict the IoT data inconsistency; and
generating, using the labelled IoT data and the features of IoT data inconsistency, a set of inconsistency rules to be applied to live IoT data predicted as inconsistent by the ML model.
